(19) United States
(12) Patent Application Publication
(10) Pub. No.: US 2014/0038043 A1
(43) Pub. Date: Feb. 6, 2014

(54) CATHODE ACTIVE MATERIAL, NON-AQUEOUS ELECTROLYTE SECONDARY BATTERY, AND METHOD FOR PRODUCING CATHODE ACTIVE MATERIAL

(71) Applicants: THE FURUKAWA BATTERY CO., LTD., Yokohama-shi (JP); FURUKAWA ELECTRIC CO., LTD., Tokyo (JP)

(72) Inventors: Yosuke HIRAYAMA, Tokyo (JP); Michio OHKUBO, Tokyo (JP); Yoshinori KAZAMA, Tokyo (JP); Hidetoshi ABE, Yokohama-shi (JP); Miyu NEMOTO, Yokohama-shi (JP)

(73) Assignees: THE FURUKAWA BATTERY CO., LTD., Yokohama-shi (JP); FURUKAWA ELECTRIC CO., LTD., Tokyo (JP)

(21) Appl. No.: 14/046,399

(22) Filed: Oct. 4, 2013

Related U.S. Application Data
(63) Continuation of application No. PCT/JP2012/058827, filed on Apr. 2, 2012.

(30) Foreign Application Priority Data
Apr. 7, 2011 (JP) 2011-085263

(51) Int. Cl. H01M 4/505; C01B 33/32; H01M 10/052; H01M 4/525; H01M 4/131

(52) U.S. Cl. CPC H01M 4/505; H01M 4/525; H01M 4/131; H01M 10/052; C01B 33/32
USPC 429/211; 429/221; 241/25; 252/519.12; 252/519.14; 252/519.15

(57) ABSTRACT

The object of the present invention is to provide a lithium transition metal silicate-type cathode active material that shows superior cycle characteristics, and shows little deterioration of discharge capacity even after repeated charge-and-discharge. In the present invention, a cathode active material that is expressed by the general formula Li_{2-y}Fe₁₋ₓMₓSi_{1-y}X_{y}O₄ (M=at least one transition metal selected from the group consisting of Mn, Ti, Cr, V, Ni, Co, Cu, Zn, Al, Ge, Zr, Mo, W; X=at least one element selected from the group consisting of Ti, Cr, V, Zr, Mo, W, P, B; 0≦x<1, 0≦y<0.25), and contains a lithium transition metal silicate, which comprises a mixed phase of an orthorhombic-type structure with a space group Pmn2₁ symmetry, and a monoclinic-type structure with a space group P2₁/n symmetry, is provided.

### TECHNICAL FIELD

The present invention relates to a cathode active material that contains lithium transition metal silicate, which can be used in non-aqueous electrolyte secondary batteries.

### BACKGROUND ART

In recent years, with the mobilization and high functionality of electronic equipments, the secondary battery, which is a power source, has become one of the most important parts. In particular, Li ion secondary battery has become the mainstream in place of conventional NiCd battery and Ni—H battery, due to its high energy density obtained from the high voltage of the cathode active material and anode active material. However, Li-ion secondary battery by the combination of lithium cobalt oxide (LiCoO₂)-type cathode active material and carbon-type anode active material, which is currently used in general, is incapable of sufficiently supplying the amount of electricity required for today's high-functionality high-intensity electronic parts, and is incapable of fulfilling the required performance of a portable power source.

The theoretical electrochemical specific capacity of the cathode active material is generally small, and in those other than cobalt acid-type lithium, such as manganic acid-type lithium and nickel acid-type lithium, as well as in iron phosphate-type lithium, which is being studied for future practical use, remain to be of smaller values than the theoretical specific capacity of the current carbon-type anode active material. However, the carbon-type anode active material, whose performance has been rising little by little every year, is also approaching the theoretical specific capacity, and it is becoming impossible to anticipate large improvement in power source capacity with the current combination of cathode and anode active materials. There appears to be a limitation in meeting requirements for high-functionality and long mobile running of electronic devices, for loading on to industrial applications such as electric power tools, uninterruptible power sources, and electric storage devices, for which adoption is spreading, or for electric-powered vehicles.

Under such circumstances, metal-type anode active materials are being examined for application, as a method to dramatically increase the electric capacity than that currently possible, in place of the carbon (C)-type anode active material. Such method enables several to ten times the theoretical specific capacity of the current carbon-type anode. These utilize germanium (Ge), tin (Sn), and silicon (Si)-type materials as the anode active material, and in particular, Si is in the center of study, since it has a specific capacity that is comparable to that of metallic Li, which is said to be difficult to put to practical use.

However, in the present situation, because the specific capacity of the cathode active material that is to be used in combination is low, the large theoretical specific capacity of Si is not being put to use in actual batteries. The per-unit-mass theoretical specific capacity of the layered halite-type or spinel-type complex oxides are slightly over 150 mAh/g at most, which is less than half the specific capacity of the present carbon-type anode active material, and 1/20 or less of the theoretical specific capacity of Si. For this reason, the examination of substance systems in aim of achieving higher capacity in cathode active material is also needed. As a candidate for new cathode active material, studies on lithium transition metal silicate-type compounds, such as lithium iron silicate, which are expected to exceed 300 mAh/g, or twice the conventional value, depending on the components, are beginning (for example, Patent Document 1 and Non-patent Document 1).

### RELATED ART DOCUMENTS

### Patent Documents

[Patent Document 1] JP-A-2001-266882

### Non-Patent Documents

[Non-Patent Document 1] Miki Yasutomi et al., “Synthesis and Electrochemical Properties of Li₂₋ₓM(SiO₄)₁₋ₓ(PO₄)ₓ(M=Fe, Mn) Positive Active Materials by Hydrothermal Process for Li-ion Cells”, GS Yuasa Technical Report, GS Yuasa Corporation Ltd., Vol. 6, No. 1, Jun. 26, 2009, pp. 21-26

### SUMMARY OF THE INVENTION

### Technical Problem

However, in conventional lithium transition metal silicate-type cathode active materials, there was a problem in that the cycle characteristics were inferior and that the discharge capacity deteriorated with repeated charge-and-discharge.

### Means for Solving the Problem

The present invention was made in view of the above-described problems, and its object is to provide a lithium transition metal silicate-type cathode active material that shows superior cycle characteristics and shows little deterioration in discharge capacity even after repeated charge-and-discharge.

The present inventors, through extensive studies, discovered that while calcining the particulate mixture, which is the precursor of the cathode active material, by calcining for longer hours than previous methods, a monoclinic-type structure with a space group P2₁/n symmetry appears in the lithium transition metal silicate, along with the normally-synthesized orthorhombic-type structure with a space group Pmn2₁ symmetry, and further discovered that such cathode active materials show superior cycle characteristics, thus leading to the present invention.

Hence, the present invention provides the following inventions:

(1) A cathode active material that is expressed by the general formula Li_{2-y}Fe₁₋ₓMₓSi_{1-y}X_{y}O₄ (M=at least one transition metal selected from the group consisting of Mn, Ti, Cr, V, Ni, Co, Cu, Zn, Al, Ge, Zr, Mo, W; X=at least one element selected from the group consisting of Ti, Cr, V, Zr, Mo, W, P, B; 0≦x<1, 0≦y<0.25), and contains a lithium transition metal silicate, which comprises a mixed phase of an orthorhombic-type structure with a space group Pmn2₁ symmetry, and a monoclinic-type structure with a space group P2₁/n symmetry.
(2) The cathode active material according to (1), wherein the intensity ratio I(P2₁/n)/I(Pmn2₁) of the peak intensity I (Pmn2₁) assigned to the (011) plane of said orthorhombic-type structure near 2θ=24.2 degrees and the peak intensity I (P2₁/n) assigned to the (1/2 3/2 1) plane of said monoclinic-type structure near 2θ=31.6 degrees, in an x-ray diffraction measurement using CuKα ray, is 0.1 or more and 0.3 or less.
(3) The cathode active material according to (1), wherein the amount of said lithium transition metal silicate is 10 to 30 mol % of the sum of the lithium transition metal silicate having said monoclinic-type structure and the lithium transition metal silicate having said orthorhombic-type structure.
(4) The cathode active material according to (1), wherein the half-width of the peak assigned to the (011) plane of said orthorhombic-type structure near 2θ=24.2 degrees in an x-ray diffraction measurement using CuKα ray is 0.2° or more.
(5) The cathode active material according to (1), wherein the size of the crystallite obtained by x-ray diffraction measurement using CuKα ray is in the range of 5 to 50 nm.
(6) The cathode active material according to (1), wherein the configuration of the primary particle is approximately spherical and the particle size distribution of the primary particle is in the range of 10 nm to 200 nm.
(7) A cathode for non-aqueous electrolyte secondary battery, which comprises a current collector, and a cathode active material layer containing the cathode active material of (1) on at least one side of said current collector.
(8) A non-aqueous electrolyte secondary battery, which comprises: the cathode for non-aqueous electrolyte secondary battery of (7); an anode that is able to occlude and discharge lithium ion; and a separator arranged between said cathode and said anode, wherein said cathode, said anode and said separator are provided in an electrolyte that shows lithium ion conductivity.
(9) A method for producing a cathode active material containing lithium transition metal silicate, which comprises: a process (a) of synthesizing a particulate mixture using a lithium source, a transition metal source, and a silicon source; a process (b) of mixing a carbon source to said particulate mixture; and a process (c) of calcining said particulate mixture mixed with said carbon source under inert gas atmosphere for 32 to 50 hours at 650° C. to 700° C.
(10) The method for producing a cathode active material according to (9), wherein in said process (a), a mixed solution of said lithium source, said transition metal source, and said silicon source is supplied as a mist-like droplet to a flame along with a combustion-supporting gas and a flammable gas to thereby synthesize the particulate mixture.
(11) The method for producing a cathode active material according to (10), wherein in said process (a), the temperature of said flame is 1000 to 3000° C.
(12) The method for producing a cathode active material according to (10), wherein in said process (a), said flammable gas is a hydrocarbon-type gas, and said combustion-supporting gas is air.
(13) The method for producing a cathode active material according to (9), wherein said process (a) is a process in which the mist-like droplet of the mixed solution of said lithium source, said transition metal source, and said silicon source is heated to thereby synthesize the particulate mixture.
(14) The method for producing a cathode active material according to (9), wherein said carbon source is one or more of poly vinyl alcohol, sucrose, and/or carbon black.
(15) The method for producing a cathode active material according to (9), which comprises a process of pulverizing said lithium transition metal silicate-type cathode active material following said process (c).

### Effect of the Invention

The present invention can provide a lithium transition metal silicate-type cathode active material that shows superior cycle characteristics, and shows little deterioration of discharge capacity even after repeated charge-and-discharge.

### BRIEF DESCRIPTION OF THE DRAWINGS

FIG. 1: a schematic diagram that shows the particulate production apparatus used in the spray-combustion method for producing the particulate mixture of the present invention.

FIG. 2: a schematic sectional diagram that shows the non-aqueous electrolyte secondary battery that utilizes the cathode active material of the present invention.

FIG. 3: (a) an orthorhombic-type structure with a space group Pmn2₁ symmetry; (b) a monoclinic-type structure with a space group P2₁/n symmetry; (c) a XRD pattern of the lithium transition metal silicate that comprises a mixed phase of the orthorhombic-type structure and the monoclinic-type structure; (d) a XRD pattern estimation by calculation of the orthorhombic-type structure with a space group Pmn2₁ symmetry; (e) a XRD pattern estimation by calculation of the monoclinic-type structure with a space group P2₁/n symmetry.

FIG. 4: (a) particulate mixture prior to calcination; (b) Comparative Example 1 after heating for 8 hours; (c) Example 1 after heating for 32 hours; (d) XRD measurement result for Comparative Example 2 after heating for 88 hours.

FIG. 5: (a) a HAADF-STEM image of the cathode active material of Example 1 after calcination; (b) an EDS map for silicon atom from the same observation point; (c) an EDS map for iron atom from the same observation point; (d) an EDS map for oxygen atom from the same observation point.

FIG. 6: a graph that shows the capacity maintenance factor against the initial capacity of the non-aqueous electrolyte secondary battery that utilizes the cathode active material of (a) Example 1 and (b) Comparative Example 1.

### MODE FOR CARRYING OUT THE INVENTION

Hereinafter, favorable embodiments of the particulate mixture and the cathode active material etc. of the present invention will be described. Note that the present invention is not limited to these embodiments.

The cathode active material of the present invention is obtained and provided as a powdery material. Further, the cathode active material may be provided as it is, or may be subjected to a granulation process to increase its sizes and provided as a secondary particle, or may be provided as a slurry of aqueous solvent or organic solvent with dispersants, thickeners, or conductive agents added thereto at a certain proportion. Furthermore, such cathode active material may be provided in the form of an electrode, by applying such slurry onto a current collector substrate and forming a film. Moreover, the secondary battery of the present invention utilizes the cathode for secondary battery of the present invention, and is provided by constructing a secondary battery along with other constituent materials such as known anodes, separators, and electrolytes.

The cathode active material of the present invention is synthesized by heat treatment of a particulate mixture, which is an active material precursor. The particulate mixture is synthesized by supplying its component raw materials into the same reaction system.

### (Method for Producing the Particulate Mixture by a Spray-Combustion Method)

The spray-combustion method is a method for obtaining the substance of object by supplying its component raw material into a flame, by a method of supplying raw material gas such as chlorides or by a method of supplying raw material liquid through a carburetor, whereby the component raw materials are reacted. As a spray-combustion method, the VAD (Vapor-phase Axial Deposition) method etc. may be listed as a preferable example. The temperatures of such flames depend on the mixture ratio of the flammable gas and the combustion-supporting gas or the addition ratio of the component raw material, but are normally in the range of 1000 to 3000° C., and are preferably in the range of about 1500 to 2500° C., and more preferably, in the range of about 1500 to 2000° C. When the temperature of the flame is low, the reaction may not proceed sufficiently in the flame, and may continue out of the flame. Further, when the flame temperature is high, the crystallinity of the particulate produced may become excessively high, which may lead to the production of a stable phase, which is not favorable for the cathode active material, in the subsequent calcination process.

Further, the flame-hydrolysis method is a method in which the component raw materials undergo hydrolysis in a flame. In the flame-hydrolysis method, an oxyhydrogen flame is generally used as the flame. In a flame to which hydrogen gas and oxygen gas is supplied, component raw materials of the cathode active material and flame raw materials (oxygen gas and hydrogen gas) are supplied simultaneously from a nozzle to synthesize the substance of object. In the flame-hydrolysis method, very fine nano-scaled particulates of the substance of object that is mainly amorphous can be obtained under inert gas-filled atmosphere.

Furthermore, the thermal oxidation method is a method wherein the component raw materials undergo thermal oxidation in a flame. In the thermal oxidation method, a hydrocarbon flame is generally used as the flame, and in a flame supplied with hydrocarbon gas (such as propane gas) and oxygen gas, the component raw materials and the flame raw materials (for example, propane gas and oxygen gas) are simultaneously supplied from a nozzle, whereby the substance of object is synthesized.

The component raw materials for obtaining the particulate mixture of the present invention are a lithium source, a transition metal source, and a silicon source. For example, solutions of a the lithium source such as lithium naphthenate, a transition metal source such as iron octylate, and a silicon source such as octylmethyl cyclotetrasiloxane (OMCTS), are used. If the raw material is solid, it may be supplied as a powder or may be dispersed in a liquid or dissolved in a solvent and supplied into the flame via a carburetor. If the raw material is liquid, other than passing through a carburetor, it may be supplied as a vapor by heating, depressurizing, or bubbling to increase its vapor pressure, prior to the supply nozzle.

As a lithium source, inorganic acid salts of lithium such as lithium chloride, lithium hydroxide, lithium carbonate, lithium nitrate, lithium bromide, lithium phosphate, and lithium sulfate, organic acids of lithium such as lithium oxalate, lithium acetate, and lithium naphthenate, lithium alkoxides such as lithium ethoxide, organic lithium compounds such as β-diketonato compound of lithium, lithium oxide, and lithium peroxide, etc. can be used. Note that naphthenic acid is a mixture of different carboxylic acids, in which a plurality of acidic substances in petroleum are mixed, and its main components are carboxylic compounds of cyclopentane and cyclohexane.

As a transition metal source, chlorides of various transition metals such as ferric chloride, manganese chloride, titanium tetrachloride, and vanadium chloride, oxalates of transition metals such as iron oxalate and manganese oxalate, transition metal acetates such as manganese acetate, etc., sulfates of transition metals such as ferrous sulfate and manganese sulfate, nitrates of transition metals such as manganese nitrate, hydroxides of transition metals, such as manganese oxyhydroxide and nickel hydroxide, ethylhexanoates (also known as octylates) of transition metals such as ferric 2-ethylhexanoate and manganous 2-ethylhexanoate, tetra-(2-ethylhexyl)titanate, naphthenates of transition metals such as iron naphthenate, manganese naphthenate, chromium naphthenate, zinc naphthenate, zirconium naphthenate, and cobalt naphthenate, transition metal hexoates such as manganese hexoate, cyclopentadienyl compounds of transition metals, transition metal alkoxides such as titanium tetraisopropoxide (TTIP) and titanium alkoxide, etc. may be utilized. Moreover, organometallic salts of transition metals of stearic acid, dimethyldithiocarbamic acid, acetylacetonate, oleic acid, linoleic acid, and linolenic acid etc., and oxides of various transition metals such as iron oxide and manganese oxide, may be utilized depending on conditions.

As described later, to use two or more types of transition metals as the lithium transition metal silicate compound, two or more types of raw materials of transition metal materials are supplied into the flame.

As a silicon source, silicon tetrachloride, octamethylcyclotetrasiloxane (OMCTS), silicon dioxide, silicon monoxide, or hydrates of such silicon oxides, condensed silicates such as orthosilicate, metasilicate, and meta-2 silicate, tetraethyl orthosilicate (tetraethoxy-silane, TEOS), tetramethyl orthosilicate (tetramethoxysilane, TMOS), methyl trimethoxysilane (MTMS), methyl triethoxysilane (MTES), hexamethyl disiloxane (HMDSO), tetramethyl disiloxane (TMDSO), tetramethyl cyclotetrasiloxane (TMCTS), octamethyl trisiloxane (OMTSO), and tetra-n-butoxysilane, etc. can be utilized.

Furthermore, when part of the silicate in the lithium transition metal silicate compound is substituted by another anion, transition metal oxides, raw materials of phosphoric acid, and raw materials of boric acid are added as an anion source.

For example, titanium oxide, titanites such as iron titanite and manganese titanite, titanates such as zinc titanate, magnesium titanate and barium titanate, vanadium oxide, ammonium metavanadate, chromium oxide, chromates and dichromates, manganese oxide, permanganates and manganates, cobaltates, zirconium oxide, zirconates, molybdenum oxides, molybdates, tungsten oxide, tungstates, phosphates such as orthophosphate and metaphosphate, pyrophoric acid, ammonium hydrogen phosphates such as diammonium hydrogen phosphate and ammonium di-hydrogen phosphate, various phosphates and pyrophosphates such as ammonium phosphate and sodium phosphate, as well as phosphates with transition metals introduced such as ferrous phosphate, various borates such as boric acid, boron trioxide, sodium metaborate, sodium tetraborate, and borax can be used along with the respective desired anion source according to the synthesis conditions.

These materials are supplied to the same reaction system along with flame materials to synthesize the particulate mixture. The generated particulate mixture can be recovered by a filter from the exhaust. Further, as stated below, it may be produced on the perimeter of a wick stick. By installing a wick stick (also known as a core stick) of silica or a silicon-type material into the reaction vessel, supplying a lithium source, a transition metal source, and a silicon source in an oxyhydrogen flame or a propane flame, to thereby perform hydrolysis or oxidization, a particulate of nano-order is generated and collected on the surface of the wick stick. These generated particulates are collected and filtered or sieved as necessary to remove impurities and large condensations. The particulate mixture thus obtained has a very fine particle diameter of nano-scale, and mainly consists of amorphous particulates.

In the spray-combustion method, which is the method for producing the particulate mixture of the present invention, the particulate mixture produced is amorphous and the size of the particle is small. Further, in the spray-combustion method, quantity synthesis in a short period of time, as compared with conventional hydrothermal synthesis methods and solid phase synthesis methods, is made possible, and a homogeneous particulate mixture can be obtained at low cost.

### (Features of the Particulate Mixture Obtained by the Spray-Combustion Method)

The particulate mixture is composed of amorphous particulates consisting mainly of lithium, transition metal, oxides of silicon, and lithium transition metal silicate, but often also contains crystalline oxides of transition metals. Further, it may partly contain crystalline components of the lithium transition metal silicate-type compound.

By measuring the powder x-ray diffraction of such particulate mixture in the range of 2θ=10 to 60°, a wide angle of diffraction with a small diffraction peak is obtained. These presumably indicate diffractions derived from each lithium transition metal silicate-type compound crystal planes of particulates with small crystallites, polycrystalline particulates formed of aggregated small single crystals, and microcrystallites wherein amorphous components exist around such particulates. Note that the position of the peak may shift about ±0.1° to ±0.2° due to distortions of the crystal and measurement errors.

In the spray-combustion method of the present invention, carbon is combusted in the flame, and thus, the particulate mixture obtained does not contain carbon. Even if carbon components are mixed in, their amount would be minimal, and are not enough to serve as conductive agents for use as a cathode.

### (Method for Producing Particulate Mixture by the Spray-Thermal Decomposition Method)

Furthermore, the particulate mixture, which is an active material precursor, may be produced by the spray-thermal decomposition method. The spray-thermal decomposition method is a method for obtaining the particulate mixture, by forming mist-like droplets of a mixed solution containing a lithium source, a transition metal source, and a silicon source, passing them through a reaction vessel that is heated to about 500 to 900° C., and subjecting to thermal decomposition by heating. Heating in a reaction vessel may be done using an electric furnace or a flame furnace.

The types of lithium source, transition metal source, and silicon source that can be used, and the fact that mist-like droplets are formed are similar to the aforementioned spray-combustion method. However, the spray-thermal decomposition method differs in that the reaction occurs at a much lower temperature in a reaction vessel, while in the spray-combustion method, the reaction occurs in a flame at around 2000° C. Further, the two differ in that while the carrier gas for the mist-like droplet is air or inert gas in the spray-thermal decomposition method, that in the spray-combustion method contains a flammable gas and a combustion-supporting gas. Furthermore, the two differ in that the reaction time is longer in the spray-thermal decomposition method compared to the heat combustion method, because it is performed in a reaction vessel.

As with the spray-combustion method, in the spray-thermal decomposition method, a particulate mixture composed mainly of amorphous particulates of lithium, transition metal, oxides of silicon, and lithium transition metal silicate, which is an active material precursor, is obtained.

### (Method for Producing Cathode Active Material)

By heat treating the particulate mixture, the amorphous compounds and oxide-form mixtures in the particulate mixture change in to a crystalline-form compound mainly of lithium transition metal silicate-type, and the lithium transition metal silicate-type cathode active material is obtained. By performing the heat treatment for longer hours than in conventional methods, a monoclinic-type structure with a space group P2₁/n symmetry that had not been obtainable previously, is obtained.

First, in order to enhance the conductivity of the product after heat-treatment, a carbon source, which may be a polyalcohol such as polyvinyl alcohol, a saccharide such as sucrose, or carbon black, is added and mixed with the particulate mixture. Here, polyvinyl alcohol, which is a type of polyalcohol, is favorable because it not only serves as a carbon source, but can also reduce the iron component during calcination.

Then, the mixture of the particulate mixture and the carbon source is subjected to calcination in an inert gas-filled atmosphere. As the inert gas, nitrogen gas, argon gas, neon gas, helium gas, carbon dioxide gas etc. may be used. The calcination condition is a temperature of 650 to 750° C. at a treatment time of 32 hours or more. With such temperature range and treatment time, a mixed phase of the orthorhombic-type structure with a space group Pmn2₁ symmetry and the monoclinic-type structure with a space group P2₁/n symmetry can be obtained. The excessive heat load of heat treatment at higher temperature and longer hours leads to the precipitation of iron crystals, and thus should be avoided. The treatment time should be 50 hours or less.

Subsequently, the calcined particulate mixture may be subjected to various pulverization means such as mortar and ball mill to prepare a fine particulate. Thus, the cathode active material of the present invention that is sufficient as an intercalation host for Li ion is obtained.

### (Features of the Cathode Active Material of the Present Invention)

The lithium transition metal silicate contained in the thus-obtained cathode active material is expressed as Li_{2-y}Fe₁₋ₓMₓSi_{1-y}X_{y}O₄ (M=at least one transition metal selected from the group consisting of Mn, Ti, Cr, V, Ni, Co, Cu, Zn, Al, Ge, Zr, Mo, W; X=at least one element selected from the group consisting of Ti, Cr, V, Zr, Mo, W, P, B; 0≦x<1, 0≦y<0.25). It may contain transition metals other than iron, as opposed to lithium iron silicate, and may contain anions other than silicic acid.

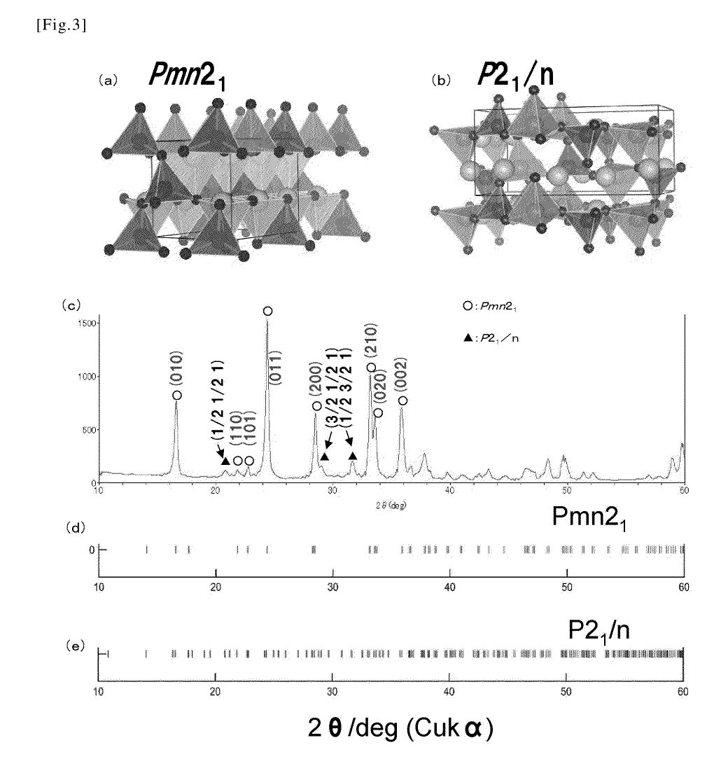

Because the cathode active material of the present invention undergoes longer hours of calcination process, a monoclinic-type structure with a space group P2₁/n symmetry as shown in FIG. 3(b) appears, along with the orthorhombic-type structure with a space group Pmn2₁ symmetry shown in FIG. 3(a). The cathode active material in which a monoclinic-type structure appears shows superior cycle characteristics compared to conventional cathode active materials that only show an orthorhombic-type structure.

The monoclinic-type structure with a space group P2₁/n symmetry shown in FIG. 3(b) is a superlattice structure, which has twice the volume of the orthorhombic-type structure with a space group Pmn2₁ symmetry shown in FIG. 3(a). The tetrahedron of FeO₄ and SiO₄ in the space group Pmn2₁ model becomes a structure that is periodically inverted in the space group P2₁/n model. The XRD pattern and assignment of each peak for the lithium transition metal silicate that has a mixed phase of the monoclinic-type structure and the orthorhombic-type structure are shown in FIG. 3(c). Further, the estimation patterns of the x-ray diffraction for each structure by calculation, which is the basis for each assignment, are shown in FIGS. 3(d) and (e).

Furthermore, according to simulation, it is known that lithium transition metal silicates that comprise a monoclinic-type structure with a space group P2₁/n symmetry requires low energy when extracting lithium ion from the crystal, and that they have a highly stable crystal structure.

In the cathode active material of the present invention, the intensity ratio I(P2₁/n)/I(Pmn2₁) of the peak intensity I (Pmn2₁) assigned to the (011) plane of said orthorhombic-type structure near 2θ=24.2 degrees and the peak intensity I (P2₁/n) assigned to the (1/2 3/2 1) plane of said monoclinic-type structure near 2θ=31.6 degrees, in the x-ray diffraction measurement using CuKα ray, is preferably 0.1 or more and 0.3 or less.

If this intensity ratio is less than 0.1, the cathode active material will not differ much from that with only the orthorhombic-type structure, and will show little effect in enhancing the cycle characteristic. Further, if a cathode active material with an intensity ratio that is more than 0.3 were to be prepared, long hours of heating would be required in the production method of the present invention, which causes iron to precipitate in the cathode active material, and is thus not preferable.

Further, in the cathode active material of the present invention, the amount of the lithium transition metal silicate having a monoclinic-type structure is preferably 10 to 30 mol % of the sum of the lithium transition metal silicate having a monoclinic-type structure and the lithium transition metal silicate having said orthorhombic-type structure.

If the ratio of the monoclinic-type structure is less than 10 mol %, the cathode active material will not differ much from that with only the orthorhombic-type structure, and will show little effect in enhancing the cycle characteristic. Further, if a cathode active material with a ratio of the monoclinic-type structure of more than 30 mol % were to be prepared, long hours of heating would be required in the production method of the present invention, which causes iron to precipitate in the cathode active material, and is thus not preferable.

The cathode active material of the present invention is characteristic in that the half-width of the peak assigned to the (011) plane of the orthorhombic-type structure having a space group Pmn2₁ symmetry near 2θ=24.2 degrees is 0.2° or more. This is because the cathode active material of the present invention is obtained by calcining a particulate mixture composed of amorphous particulates, and the crystallinity decreases compared to conventional methods such as the solid-phase reaction method and the hydrothermal synthesis method. Note that the half-width is usually 1° or less, and in many cases, is 0.6° or less.

Furthermore, the cathode active material of the present invention is characteristic in that the size of the crystallite obtained by the Scherrer's equation is in the range of 5 to 50 nm. As previously stated, this is because the cathode active material of the present invention is obtained by calcining an amorphous particulate mixture, and the crystallite size becomes smaller than conventional methods such as the solid-phase reaction method and the hydrothermal synthesis method. In most cases, it is in the range of 20 to 40 nm. Because the crystallite is small, lithium can easily enter and exit during large current charge-and-discharge and the rate property is enhanced.

Although most of the crystallized lithium transition metal silicate-type compounds in the cathode active material of the present invention are fine crystallites, there exists a “microcrystallite” state that partly contain amorphous components. For example, a state wherein particulates constituted of multiple crystallites aggregated together are covered with an amorphous component, or a state wherein fine crystals exist in a matrix of amorphous contents, or a state wherein amorphous contents exist around and in between particulates, is referred to.

Further, when the cathode active material of the present invention is subjected to transmission electron microscope (TEM) observation to measure the particle diameter, and the particle size distribution is obtained, it exists in the range of 10 to 200 nm, and the average value exist in 25 to 100 nm. These particles are composed of multiple aggregated crystallites. Furthermore, it is preferred that the particle size distribution is in the range of 10 to 150 nm, and that the average value is 25 to 80 nm. Note that the particle size distribution existing in the range of 10 to 200 nm does not necessarily mean that the particle size distribution obtained exist throughout the entire range from 10 to 200 nm, but merely means that the minimum of the particle size distribution is 10 nm or more, and that the maximum is 200 nm or less. That is, the particle size distribution may be 10 to 100 nm, or may be 50 to 150 nm.

In the cathode active material of the present invention, since the particle size is small, the conductive path of Li ion or electrons in the single crystal or polycrystal particle is short. Thus, its ion conductivity and electron conductivity is superior, and is capable of lowering the barrier of the charge-and-discharge reaction.

The cathode active material of the present invention shows an approximately spherical configuration. Although angular areas are partly observed, as a whole, it shows an approximately spherical configuration.

In the cathode active material of the present invention, it is preferable that the lithium transition metal silicate particulate is at least partially carbon-coated or is at least partly supported with carbon. Carbon-coating refers to the coating the surface of a particle with carbon, and carbon-supporting refers to the state of containing carbon within the particle. By carbon-coating or carbon-supporting, the conductivity of the material increases, and a conductive path to the lithium transition metal silicate particulate is obtained. Thus, the electrode characteristic when using as a cathode is enhanced.

The cathode active material obtained shows different properties in charge-and-discharge capacity etc. depending on the type of transition metal used. For example, when Fe raw materials are used as the transition metal source, the crystalline structure stabilizes and can be easily synthesized at low cost. However, the capacity remains in the conventional level with Fe alone. For the Mn raw material, it is also low in cost and easily synthesized, but there exists a problem in that the crystalline structure of lithium manganese silicate easily disintegrate with the intercalation and de-intercalation of Li, and its charge-and-discharge cycle life tends to be short. Hence, by using two transition metal elements, as in lithium iron manganese silicate (Li₂Fe₁₋ₓMnₓSiO₄) that utilizes both Fe and Mn raw materials, the aforementioned problem of low capacity and crystal structure disintegration can be solved. The same can be said for those other than Fe and Mn, such as Ti, Cr, V, Ni, Co, Cu, Zn, Al, Ge, Zr, Mo, and W.

On the other hand, the same can be said for the anion or polyanion (SiO₄)ₙ silicate, and part of the (SiO₄)ₙ can be substituted with another anion. For example, there are acids of the said transition metals such as titanic acid (TiO₄), chromic acid (Cro₄), vanadic acid (VO₄, V₂O₇), zirconic acid (Zro₄), molybdic acid (MoO₄, Mo₇O₂₄), tungstic acid (WO₄), etc., and substitution by phosphoric acid (PO₄) and boric acid (Bo₃) may be listed. By substituting part of the polysilicic acid ion with these anions, the change in crystalline structure due to repeated Li dissociation and occlusion can be suppressed, contributing to its stabilization, which enhances the cycle life. Further, since these anions hardly release oxygen even at high temperature, there is less chance of causing firing, and can thus be used safely.

### (Method of Producing Cathode for Non-Aqueous Electrolyte Secondary Battery)

In order to prepare a cathode using the cathode active material obtained by the heat treatment of the particulate mixture, to the cathode active material powder, conductive materials coated or supported with carbon such as carbon black (especially acetylene black) is added, along with binding agents such as polytetrafluoroethylene, polyvinylidene fluoride, and polyimide, dispersants such as butadiene rubber, thickeners such as carboxymethyl cellulose and other cellulose derivatives. This mixture is added to a matrix of aqueous solvent or organic solvent to form a slurry, and applied on one or both surfaces of a current collector such as aluminum alloy foil that contains 95 wt % or more of aluminum, then evaporated and solidified by calcination. Thus, the cathode of the present invention is obtained.

Here, in order to enhance the applicability of the slurry, its adhesiveness with the active material, or its current collectivity, a secondary particle obtained by granulating the aforementioned cathode active material and the carbon source etc. through a spray-dry method and calcining said granulated particle, may be added to the slurry in place of the aforementioned active material. The cluster of the granulated secondary particle becomes a large cluster of about 0.5 to 20 μm, but the applicability of the slurry is enhanced drastically, leading to better battery electrode characteristic and service life. The slurry used in the spray-dry method may either be of aqueous solvent or non-aqueous solvent.

Furthermore, in the cathode formed by applying the slurry containing said cathode active material onto a current collector such as aluminum alloy foil, the surface roughness of the current collector surface on which the active material is formed is preferably 0.5 μm or more for the ten-point average roughness Rz, specified by the Japanese Industrial Standards (JIS B0601-1994). The adhesiveness of the formed active material layer and the current collector is enhanced, and the electron conductivity accompanying the insertion-and-desorption of Li ion, as well as the current collectivity to the current collector increases, leading to improved charge-and-discharge cycle life.

Furthermore, if a composite state, in which the main components of the current collector is diffused to at least the active material layer, appears at the interface of the aforementioned current collector and the active material layer formed on the current collector, the binding ability at the interface of the current collector and the active material layer improves, and tolerance against change in volume and crystalline structure with charge-and-discharge cycle increases, thereby improving the cycle life. It is more preferable when the aforementioned surface roughness condition of the current collector is fulfilled. Under a calcination condition that is sufficient to vaporize the solvent, an interface state with mutual components, wherein the current collector component is diffused to the active material layer, is formed, which shows superior adhesiveness, tolerates volume change due to the entrance and exit of Li ion even after repeated charge-and-discharge, and enhances cycle life.

### (Non-Aqueous Electrolyte Secondary Battery)

In order to obtain a high capacity secondary battery that uses the cathode of the present invention, various materials, such as anodes that utilize known anode active materials, electrolyte solutions, separators, cell casings, etc. can be used without particular restriction. The non-aqueous electrolyte secondary battery of the present invention forms a battery structure by providing a separator between the above-described cathode and anode. Such battery structure may be rolled or folded and inserted in a cell casing of cylindrical or rectangular shape, after which the electrolyte solution is injected to complete a lithium ion secondary battery.

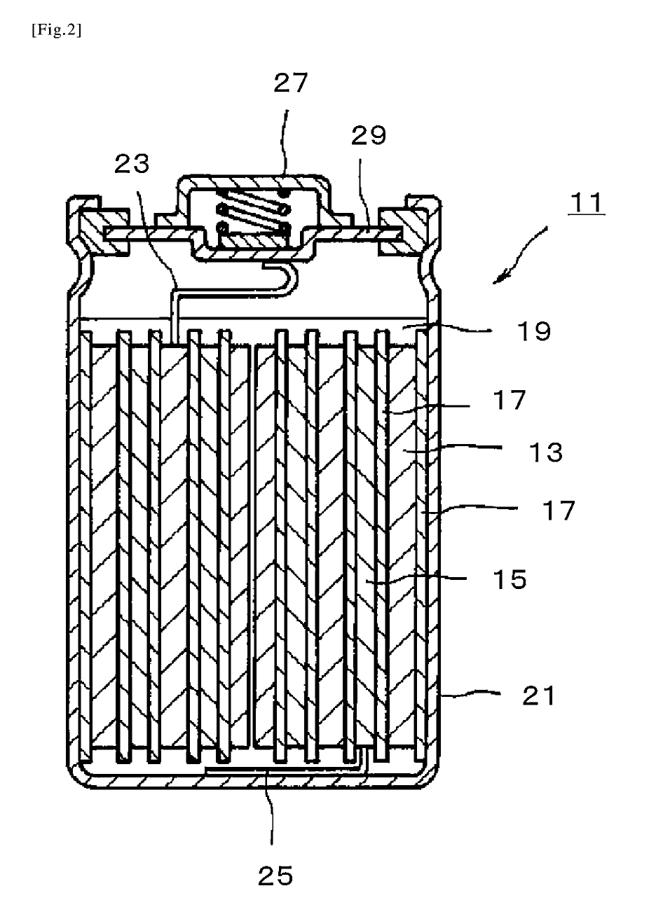

More specifically, as shown in FIG. 2, in the non-aqueous electrolyte secondary battery 11 of the present invention, the cathode 13 and anode 15 are arranged in layers via the separator 17 in the order of separator-anode-separator-cathode, wound so that the group of electrodes is arranged with the cathode 13 on the inside, and inserted in a battery case 21. Then, the cathode 13 is connected to the cathode terminal 27 via a cathode lead 23, and the anode 15 is connected to the battery case 21 via an anode lead 25, so that the chemical energy generated within the non-aqueous electrolyte secondary battery 11 may be extracted out as electric energy. Subsequently, the battery case 21 is filled with a non-aqueous electrolyte 19, and a sealing material 29 comprising a circular cover plate and a cathode terminal 27 on its top as well as a safety valve mechanism on the inside, is attached to the top end (opening) of the battery case 21 via a ring-shaped insulation gasket, to produce the non-aqueous electrolyte secondary battery 11 of the present invention.

Although the secondary battery that utilizes the cathode of the present invention shows high capacity and excellent electrode properties, by adding or using a non-aqueous solvent containing fluoride in the non-aqueous electrolyte solution that constitutes the secondary battery, the decrease in capacity by repeated charge-and-discharge can be inhibited, and its service life can be prolonged. For example, in particular, when using an anode that comprises a high capacity silicon-type anode active material, in order to inhibit the large expansion and contraction due to the doping and undoping of Li ion, it is desirable to use an electrolyte solution that contains fluorine, or an electrolyte solution that contains a non-aqueous solvent that has fluorine as a substituent. Since a fluorine-containing solvent reduces the volume expansion of the silicon-type film that is formed by alloying with Li ion during charging, especially in the initial charging, it can inhibit the decline in capacity due to charge-and-discharge. Fluorinated ethylene carbonate and fluorinated linear carbonate, etc. can be used as the fluorine-containing non-aqueous solvent. An example of fluorinated ethylene carbonate is mono-tetra-fluoroethylene carbonate (4-fluoro-1,3-dioxolan-2-one, FEC) and examples of fluorinated linear carbonates are methyl-2,2,2-trifluoroethyl carbonate, ethyl-2,2,2-trifluoroethyl carbonate, etc. These may be added to the electrolyte solution singly or in combination. Since fluorine substituents easily bond with silicon and are tough, it is thought that it stabilizes the film even during expansion due to charge-alloying with Li ion, and contributes to inhibiting expansion.

### (Effect of the Present Invention)

The cathode active material of the present invention contains a lithium transition metal silicate that comprises a mixed phase of an orthorhombic-type structure with a space group Pmn2₁ symmetry and a monoclinic-type structure with a space group P2₁/n symmetry, and therefore shows superior cycle characteristics and provides a cathode active material with a long service life.

The cathode active material for secondary battery of the present invention contains fine crystals and primary particles of nano-scale that did not exist in conventional materials. Further, since it shows low crystallinity, the travel distance of Li ion and electron is small, and thus, is superior in ion conductivity and electron conductivity. Therefore, the large capacity that lithium transition metal silicate-type compounds inherently hold can be obtained during charge-and-discharge.

Furthermore, by utilizing the cathode active material of the present invention, the Li ion conductivity and electron conductivity of the active material particle itself is enhanced, resulting in facilitating the deintercalation and intercalation of Li ion. The present invention is one that is to become a basis for future implementation of high charge-and-discharge capacity that is inherent to lithium transition metal silicate-type compounds.

Further, the half-width of the diffraction peak obtained by x-ray diffraction measurement of the cathode active material of the present invention is large, indicating that the size of the crystalline is small, or that the size or grain size of the particle is small. Thus, the conductive path for Li ion or electron within the single crystal or polycrystal is short, and excellent ion conductivity and electron conductivity are obtained.

Moreover, by coating or supporting conductive agents and conductive carbons, electrical conductivity and macroscopic current collectivity by an electric conduction path network to the current collector can be improved. Thus, a lithium transition metal silicate-type compound that can carry out charge-and-discharge even at low-temperature environments, such as normally-used room temperatures, can be provided.

Furthermore, compared to conventional cathode active materials, the cathode active material of the present invention is also characteristic in that it comprises a microcrystallite state, in which amorphous components exist in part of the surroundings of the crystal. Such state is not obtained by the solid-state reaction method, which is generally used as the conventional production method. They are obtained by first preparing an amorphous active material precursor by, for example, supplying raw materials that act as sources for the cathode active material to the same reaction system to react within a flame, and then subjecting said precursor to calcination. According to such production method, by pulverizing the calcined particulate mixture to a microscopic size, a uniform cathode active material with small particle size of approximately spherical configuration can be obtained. Thus, it becomes possible to granulate the particulate mixture to obtain a secondary particle that is easy to apply on a current collector, and a cathode active material layer, which shows excellent adhesiveness between the current collector and the active material, with the current collector component diffused thereto, can be obtained.

When the lithium transition metal silicate-type compound in the cathode active material of the present invention contains a plurality of transition metals that undergoes a bi-electron reaction during charge-and-discharge, an even higher capacity can be obtained. Further, since the silicate-type compound does not discharge oxygen, it does not cause ignition and combustion even at high-temperature environments, and can thus provide a safe secondary battery.

### Example

Hereinafter, the present invention will be described in detail with reference to Examples. However, the present invention is not limited to such Examples.

Note that although in the following Examples, lithium iron silicate compounds were synthesized, when other transition metals are used or other anions are added to the component material, similar synthesis methods can be applied, and products can be similarly provided.

### (1-1) Example 1

### Preparation of the Particulate Mixture

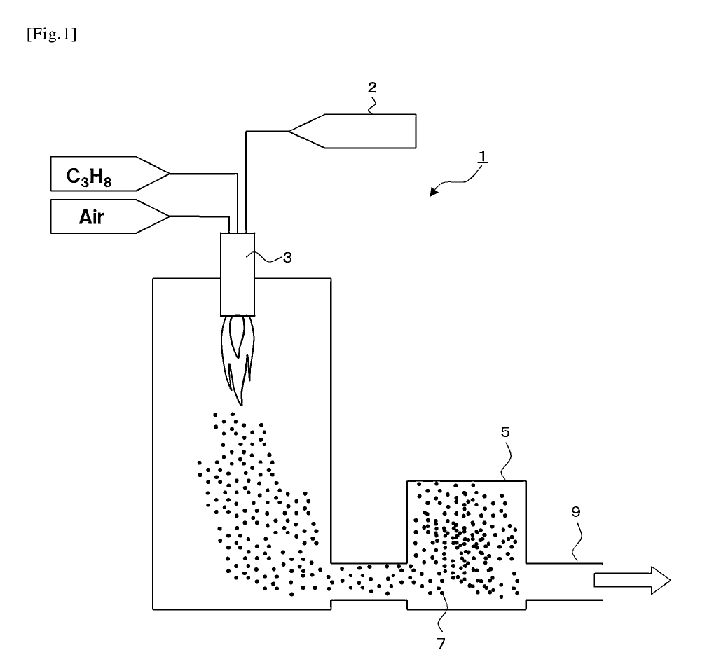

A production apparatus for producing the particulate mixture by the spray-combustion method is shown in FIG. 1. In the reaction vessel in the apparatus of FIG. 1, particulate synthesis nozzles 3 are provided within the vessel, and propane gas (C₃H₈), air (Air), and the raw material solution 2 are supplied to the flame that is generated from the nozzle 3. On the other side is an exhaust pipe 9 for evacuating the particulates produced and the reaction product, and the particulate mixture 7 is collected by the particulate collection filter 5. The types of raw material supplied to the nozzle and their supply conditions were as follows. Further, the raw material solutions were supplied to the flame, using a binary fluid nozzle, so that the size of the droplet was 20 μm. The temperature of the flame was 2000° C.

Flammable Gas: propane (C₃H₈): 1 dm³/min,

Combustion-Supporting Gas: air: 5 dm³/min,

Lithium Source: lithium naphthenate (4 M solution): 0.025 dm³/min

Iron Source: C₁₆H₃₀Feo₄ (iron(II)₂-ethylhexylate, iron octylate) (1 M solution): 0.1 dm³/min

Silicon Source: octamethyl cyclotetrasiloxane: 0.1 dm³/min,

The production method of the particulate mixture by the spray-combustion method is as follows. First, a specified amount of N₂ gas was supplied so that the interior of the reaction vessel became an inert atmosphere. Under such conditions, a mixed solution of the lithium source, iron source, and silicon source, was made into droplets of 20 μm by passing through an atomizer (binary fluid nozzle), and supplied to the flame along with propane gas and air. The particulate mixtures containing particulates of lithium oxide, iron oxide, and silicon oxide, as well as particulates of lithium iron silicates, were collected by the particulate collection filter.

### (Production of the Cathode Active Material)

Next, polyvinyl alcohol was added to the particulate mixture so that the amount of polyvinyl alcohol was 10 wt % of the total amount, and mixed.

Subsequently, the particulate mixture was inserted in a N₂ gas-filled furnace, and calcined by subjecting to 32 hours of heat-treatment at 650° C. Carbon coating or carbon supporting was performed during calcination. The calcined particulate mixture was subjected to pulverization treatment to obtain the cathode active material.

### (2-1) Comparative Example 1

Other than changing the calcination condition after the mixing of polyvinyl alcohol to 8 hours at 650° C., the cathode active material was prepared by the same method as that of Example 1.

### (2-2) Comparative Example 2

Other than changing the calcination condition after the mixing of polyvinyl alcohol to 88 hours at 650° C., the cathode active material was prepared by the same method as that of Example 1.

### (3) Confirmation by Measurement Observation of the Samples

### (3-1) Powder X-Ray Diffraction Measurement

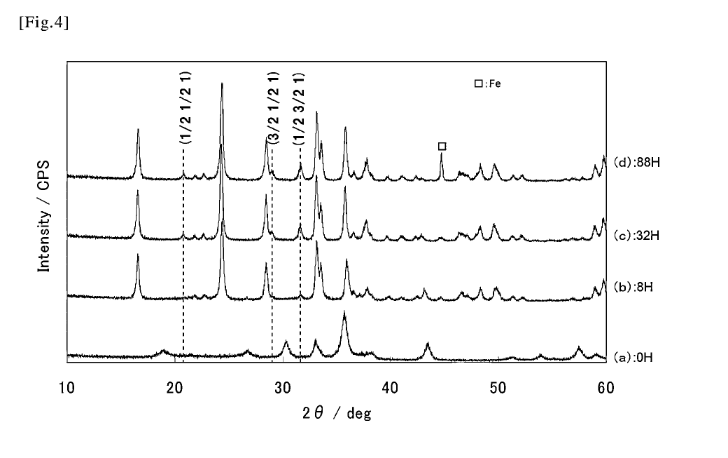

The particulate mixtures of Example 1 and Comparative Example 1, as well as the calcined cathode active material, were subjected to powder x-ray diffraction measurement (2θ=10 to 60°) using CuKα ray as the radiation source. The x-ray diffraction measurement results are shown in FIG. 4 and the analysis results are shown in Table 1.

TABLE 1

| | | Peak Intensity | Molar Ratio of | Half-Width of Peak | Crystallite Size of |
|---|---|---|---|---|---|
| | Calcination | Ratio of Monoclinic | Monoclinic and | Derived from | Peak Derived from |
| | Time | and Orthorhombic | Orthorhombic | Orthorhombic (011) | Orthorhombic (011) |
| | (hours) | Crystals | Crystals | Plane (°) | Plane (nm) |
| Comparative | 8 | 3:100 | 5:100 | 0.28 | 29 |
| Example 1 | | | | | |
| Example 1 | 32 | 15:100 | 20:100 | 0.27 | 31 |
| Comparative | 88 | 16:100 | 20:100 | 0.29 | 29 |
| Example 2 | | | | | |

As shown in FIG. 4(a), the particulate mixture, which is the active material precursor, showed a wide peak, indicating a microcrystallite configuration. Further, as shown in FIGS. 4(b) and (c), compared to Comparative Example 1, wherein the calcination time was 8 hours, in Example 1, wherein the calcination time was 32 hours, peaks derived from the (1/2 1/2 1) plane, (3/2 1/2 1) plane, and (1/2 3/2 1) plane of the monoclinic-type structure with a space group P2₁/n symmetry were apparent.

Furthermore, in Comparative Example 2, wherein the calcination time was 88 hours, the peak intensity derived from the monoclinic-type structure with a space group P2₁/n symmetry showed almost no difference from that of Example 1, but the peak around 45° derived from iron crystals became stronger, indicating that the iron crystals grew with longer hours of calcination. Note that when transition metal crystals precipitate from lithium transition metal silicates, the charge-and-discharge capacity deteriorates. This is due to the change in valence of the transition metal that occurs when the precipitated transition metal exchanges electrons with the current collector, and to the fact that the amount of lithium transition metal silicates that participate in the charge-and-discharge reaction decrease. Since in Comparative Example 2, the calcination time is 88 hours and the peak intensity of iron is stronger, by maintaining the calcination time to about 50 hours, the precipitation of transition metals can be suppressed. Note that although the crystalline structure of lithium iron silicate grows by calcining the particulate mixture, the peak is wider and the crystal particle size is smaller, compared to materials produced by conventional solid-phase reaction methods and hydrothermal synthesis methods, even after calcination.

### (3-2) Composition Analysis by EDS

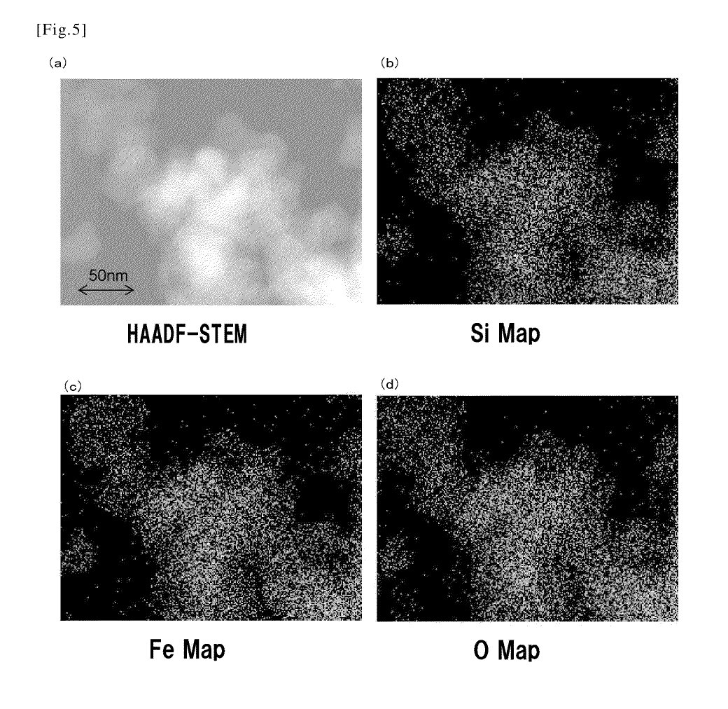

The particle configuration and composition analysis for the cathode active material of Example 1 after calcination were performed. The particle configuration was observed by HAADF-STEM (High-Angle-Annular-Dark-Field-Scanning-Transmission-Electron-Microscopy) and the composition was analyzed by EDS (Energy Dispersive Spectroscopy) analysis using a scanning transmission electron microscope (JEM 3100FEF, by JEOL Ltd.). FIG. 5(a) shows the HAADF-STEM image of the cathode active material of Example 1 after calcination, FIG. 5(b) is the EDS map for silicon atom from the same observation point, FIG. 5(c) is the EDS map for iron atom from the same observation point, and FIG. 5(d) is the EDS map for oxygen atom from the same observation point.

In FIG. 5(a), approximately spherical particles with diameters of about 20 to 100 nm were observed. In FIG. 5(b) to (d), since the distribution of oxygen, iron, and silicon atoms did not show much difference, it was confirmed that the spatial distribution of these atoms within the particle showed no unevenness and were uniform. Further, it was confirmed that there were no inclination in composition among the particles, either.

### (4) Preparation of the Cathode for Test Evaluation Using Active Material Samples, and Secondary Battery

To the cathode active materials obtained in the Example and Comparative Examples, conductive agents (carbon black) were added so that the amount became 10 wt %, and further mixed for 5 hours in a ball mill with its interior substituted by nitrogen. The mixed powder and polyvinylidene fluoride (PVdF), which is a binding agent, were mixed at a weight ratio of 95:5. N-methyl-2-pyrrolidone (NMP) was added and kneaded thoroughly, to obtain the cathode slurry.

The cathode slurry was applied to an aluminum foil current collector with a surface roughness Rz (JIS B 0601-1994 ten-point average roughness) of 0.7 nm and a thickness of 15 μm at an application amount of 50 g/m², and dried for 30 minutes at 120° C. Subsequently, it was subjected to strip processing by a roll press so that its density became 2.0 g/cm³, and a disk of 2 cm² was punched out, to thereby obtain a cathode.

The cathode, along with an anode of metal lithium, and an electrolyte solution of 1 M of LiPF₆ dissolved in a mixed solvent of ethylene carbonate and diethyl carbonate at a volumetric ratio of 1:1, were used to prepare a lithium secondary battery. Note that the preparation environment was set to a dew point of −50° C. or under. The electrodes were pressure bonded to a battery case with current collectors and used. Using the above cathode, anode, electrolyte solution and separator, a coin-type lithium secondary battery with a diameter of 25 mm and a thickness of 1.6 mm was prepared.

### (5) Test Evaluation of the Samples

Next, using the above coin-type lithium secondary battery, the cathode active material of the present invention was subjected to test evaluation as follows.

At a test temperature of 25° C., charging was performed up to 4.2 V (against Li/Li⁺) at a current rate of 0.1 C by the CC-CV method, and charging was terminated when the current rate decreased to 0.005 C. Subsequently, at a current rate of 0.1 C, discharge was performed by the CC method until the voltage (same as above) became 1.5 V, and the initial charge-and-discharge capacity was measured.

Further, under the same conditions, the charge-and-discharge capacity was measured up to 50 cycles. Note that because the measurement was temporarily terminated after 30 cycles, the graph appears to be discontinuous around 30 cycles, but the tendency in change of the capacity maintenance factor does not shift before and after 30 cycles.

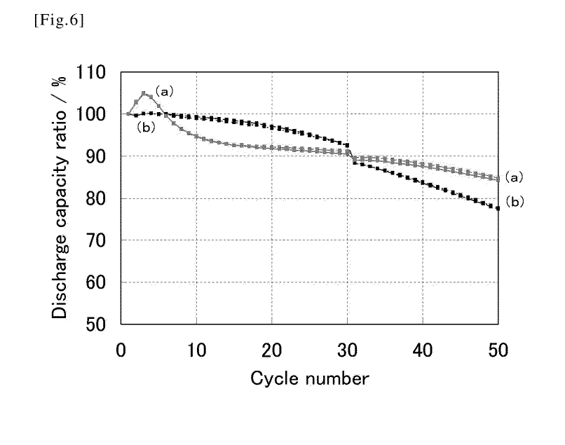

The graph of the capacity maintenance factor against the initial discharge capacity for the cathode active material of Example 1 and Comparative Example 1 are shown in FIGS. 6 (a) and (b), respectively. The charge capacity and discharge capacity for both are shown in Table 2.

TABLE 2

| | Initial | Discharge | Capacity |
|---|---|---|---|
| | Discharge | Capacity at | Maintenance Factor |
| | Capacity | 50 Cycles | at 50 Cycles |
| | (mAh/g) | (mAh/g) | (%) |
| Example 1 | 110 | 94 | 85 |
| Comparative | 105 | 82 | 78 |
| Example 1 | | | |
| Comparative | 100 | 72 | 72 |
| Example 2 | | | |

As shown in Table 1, in Example 1, the initial discharge capacity, the discharge capacity at 50 cycles, and the capacity maintenance factor at 50 cycles are all superior to those of Comparative Example 1. According to the present invention, it was discovered for the first time, that Example 1, which is a lithium iron silicate that has a mixed phase of an orthorhombic-type structure with a space group Pmn2₁ symmetry and a monoclinic-type structure with a space group P2₁/n symmetry, shows superior initial discharge capacity and cycle characteristics compared to Comparative Example 1, which is a lithium iron silicate that only has an orthorhombic-type structure. Further, in Comparative Example 2, since iron crystals were precipitated within the cathode active material, the initial discharge capacity and the capacity maintenance factor were both inferior than those of Example 1. In particular, although in the Example, cycle characteristics were evaluated at 50 cycles, actual battery products are used for at least about 500 cycles, and thus, this difference between the Example and Comparative Examples will become more apparent.

Note that although the particulate mixture was formed by the spray-combustion method in the above Example, particulate mixtures prepared by the spray-thermal decomposition method may also be applied to obtain the monoclinic-type structure, since both methods are common in that the particulate mixtures are calcined to generate the lithium transition metal silicate.

Further, although iron was used as the transition metal in the above-described Example, it is assumed that transition metals other than iron may also be added, and anions other than silicon may also be added, to obtain the monoclinic-type structure.

As described above, the cathode obtained by applying the cathode active material of the present invention on a specified current collector can be used as a cathode that shows superior charge-and-discharge behavior in various chargeable and dischargeable secondary batteries such as lithium ion secondary batteries that utilize non-aqueous electrolytes. By further improvements, the compound group of the present invention can become the foundation for enhancing the charge-and-discharge behavior even more, with higher theoretical specific capacity inherent to such compounds in view. Thus, properties of higher energy or higher output, not available conventionally, can be added to applications in conventional electronic equipments, as well as in industrial and automotive applications that are being put into practical use. Moreover, among the production methods of the particulate mixture of the present invention, the spray-combustion method is excellent in mass productivity, and is capable of providing products at low cost.

As described in detail above, suitable embodiments of the present invention were described with reference to the accompanying figures. However, the present invention is not limited to such examples. It should be understood by those in the field that examples of various changes and modifications are included within the realm of the technical idea of the present invention, and that such examples should obviously be included in the technical scope of the present invention.

### DESCRIPTION OF NOTATIONS

1 Particulate Production Apparatus
2 Raw Material Solution
3 Particulate Synthesis Nozzle
5 Particulate Collection Filter
7 Particulate Mixture
9 Exhaust Pipe
11 Non-aqueous Electrolyte Secondary Battery
13 Cathode
15 Anode
17 Separator
19 Electrolyte
21 Battery Case
23 Cathode Lead
25 Anode Lead
27 Cathode Terminal
29 Sealing Material

1. A cathode active material that is expressed by the general formula Li_{2-y}Fe₁₋ₓMₓSi_{1-y}X_{y}O₄ (M=at least one transition metal selected from the group consisting of Mn, Ti, Cr, V, Ni, Co, Cu, Zn, Al, Ge, Zr, Mo, W; X=at least one element selected from the group consisting of Ti, Cr, V, Zr, Mo, W, P, B; 0≦x<1, 0≦y<0.25), and contains a lithium transition metal silicate, which comprises a mixed phase of
an orthorhombic-type structure with a space group Pmn2₁ symmetry, and
a monoclinic-type structure with a space group P2₁/n symmetry.

2. The cathode active material according to claim 1, wherein the intensity ratio I(P2₁/n)/I(Pmn2₁) of the peak intensity I (Pmn2₁) assigned to the (011) plane of said orthorhombic-type structure near 2θ=24.2 degrees and the peak intensity I (P2₁/n) assigned to the (1/2 3/2 1) plane of said monoclinic-type structure near 2θ=31.6 degrees, in an x-ray diffraction measurement using CuKα ray, is 0.1 or more and 0.3 or less.

3. The cathode active material according to claim 1, wherein the amount of said lithium transition metal silicate is 10 to 30 mol % of the sum of the lithium transition metal silicate having said monoclinic-type structure and the lithium transition metal silicate having said orthorhombic-type structure.

4. The cathode active material according to claim 1, wherein the half-width of the peak assigned to the (011) plane of said orthorhombic-type structure near 2θ=24.2 degrees in an x-ray diffraction measurement using CuKα ray is 0.2° or more.

5. The cathode active material according to claim 1, wherein the size of the crystallite obtained by x-ray diffraction measurement using CuKα ray is in the range of 5 to 50 nm.

6. The cathode active material according to claim 1, wherein the configuration of the primary particle is approximately spherical and
the particle size distribution of the primary particle is in the range of 10 nm to 200 nm.

7. A cathode for non-aqueous electrolyte secondary battery, which comprises
a current collector, and
a cathode active material layer containing the cathode active material of claim 1 on at least one side of said current collector.

8. A non-aqueous electrolyte secondary battery, which comprises:
the cathode for non-aqueous electrolyte secondary battery of claim 7;
an anode that is able to occlude and discharge lithium ion; and
a separator arranged between said cathode and said anode,
wherein
said cathode, said anode and said separator are provided in an electrolyte that shows lithium ion conductivity.

9. A method for producing a cathode active material containing lithium transition metal silicate, which comprises:
a process (a) of synthesizing a particulate mixture using a lithium source, a transition metal source, and a silicon source;
a process (b) of mixing a carbon source to said particulate mixture; and
a process (c) of calcining said particulate mixture mixed with said carbon source under inert gas atmosphere for 32 to 50 hours at 650° C. to 700° C.

10. The method for producing a cathode active material according to claim 9, wherein in said process (a),
a mixed solution of said lithium source, said transition metal source, and said silicon source is supplied as a mist-like droplet to a flame along with a combustion-supporting gas and a flammable gas to thereby synthesize the particulate mixture.

11. The method for producing a cathode active material according to claim 10, wherein in said process (a),
the temperature of said flame is 1000 to 3000° C.

12. The method for producing a cathode active material according to claim 10, wherein in said process (a),
said flammable gas is a hydrocarbon-type gas, and
said combustion-supporting gas is air.

13. The method for producing a cathode active material according to claim 9, wherein said process (a) is a process in which
the mist-like droplet of the mixed solution of said lithium source, said transition metal source, and said silicon source is heated to thereby synthesize the particulate mixture.

14. The method for producing a cathode active material according to claim 9, wherein said carbon source is one or more of poly vinyl alcohol, sucrose, and/or carbon black.

15. The method for producing a cathode active material according to claim 9, which comprises a process of pulverizing said lithium transition metal silicate-type cathode active material following said process (c).
